(19) United States
(12) Patent Application Publication
(10) Pub. No.: US 2012/0035758 A1
(43) Pub. Date: Feb. 9, 2012

(54) DEVICE FOR COATING AN ELONGATED WORKPIECE

(76) Inventor: Armin Hummel, Bohen (DE)

(21) Appl. No.: 13/001,601

(22) PCT Filed: Jun. 24, 2009
(86) PCT No.: PCT/EP09/04572

§ 371 Date: Aug. 30, 2011

(30) Foreign Application Priority Data
Jun. 24, 2008 (DE) 10-2008-029-710.0

(51) Int. Cl. G06F 19/00; B05C 5/00

(52) U.S. Cl. 700/192; 118/300; 118/320

(57) ABSTRACT

The invention relates to a device (10) for coating an elongated work-piece (20), particularly for painting or impregnating a joined wooden workpiece, having at least one nozzle (14) directed toward the workpiece (20), wherein the nozzle (14) is disposed on a holder (11) aligned substantially perpendicular to the workpiece longitudinal axis and being suspended in a frame (17), and preferably being disposed in a rotating assembly (12). The invention further comprises a method for coating an elongated, rod-shaped work-piece (20) and a system (40), comprising the device (10), and on which the method according to the invention can be carried out.

The invention relates to a device for coating an elongated workpiece with the pre-characterizing features of claim 1 and an associated method as well as an associated system.

Complex buildings can be made by a large number of materials, e.g. from wood or timber materials with the help of modern scantling or joinery machines. For example, it is possible to provide complete prefabricated buildings from wood in a construction system of prefabricated components. The elongated components such as boards, beams, slats are automatically processed from a base material, f. i. from solid timber beams. The object is the increase of productivity with the manufacture of prefabricated components. However, it is problematic to protect the prefabricated components with a coating or a glaze. Conventionally, this coating is performed in a painting chamber. In order to reach uniform application of the coating material on all surfaces and recesses of the workpiece, often several painting steps are necessary. However, despite careful application of the coating material such as impregnation, it cannot be avoided that separated recesses, like e.g. halvings and other carpenter-common recesses are not finished. These uncoated parts of the workpiece then form the entrance for moisture as well as for pest, which is to be prevented by the coating. Due to the necessary repeated treating of the surface the application of the coating is one of the most complex processing steps, in particular for the recesses mentioned.

An automated application of a coating is shown in DE 42 22 349 C2 by a varnishing line for workpieces, wherein the workpieces are inserted in a painting cab, in order to be painted by a nozzle. The workpieces are fixed on holder frames which are pivotable. The device shown in this reference is mainly suited for the painting of vehicle bodies. Due to the linear extension of elongated workpieces and the complex surfaces the use of the varnishing line of DE 42 22 349 C2 is not practical. DE 11 75 126 shows another mechanism useful for coating of bodies. A paint nozzle is here arranged at a pivotable and nickable boom. The bodies to be painted are directed on a conveyor towards the boom. This system is also not practical for the coating of elongated workpieces with high linear extension, since the complex surface structures can be hardly achieved because of the limited mobility of the boom. Furthermore, the use of the device shown in DE 11 75 126 requires a painting chamber, into which the entire workpiece is introduced. This is also complex due to the linear extension of the joined workpieces.

An object of the present invention is to provide a device, a method and a system for coating an elongated workpiece which allows with smallest space requirements an all-round and complete application of a coating on workpieces with complex surface structures. This object is solved by a device according to claim 1, a method according to claim 10 as well as a system according to claim 13. Favourable embodiments of the invention are subject-matter of the dependent claims.

The device according to the invention for coating an elongated workpiece is suitable in particular for the painting of a joined wooden workpiece having at least one nozzle directed towards the workpiece. The coating material is discharged from this nozzle in the coating operation to be sprayed exactly at the corners or edges of a beam by the adjustability of the nozzle (-s) in several degrees of freedom. The coating is for example a paint, a glaze or other suitable materials to surface coating. The device according to the invention is characterised in that the nozzle is disposed on a holder aligned substantially perpendicular to the workpiece longitudinal axis and being suspended in a frame. Due to this embodiment of the device only a relatively small base is required and can be integrated in a simple and space-saving manner into an existing production system, so that the workpieces to be coated during the painting process are exactly coated or painted, i.e. by the exact alignment on the corner or edge ranges of reamings, incisions or similar recesses of a beam. An elongated workpiece is here a workpiece, which is at least 10× as long as wide, e.g. boards, but no relative compact vehicle bodies. It is favourable that the frame is formed as a fixed portal. This portal does not only serve as holder for the frame, but can also be used as holder for the control and drive elements of the device. These elements, for example a compressor for the pressurization of the coating material or a drive unit for the holder, can be suspended above the holder at the frame, thus being arranged outside of the sphere of the nozzles for the coating material in order to be not contaminated.

It is favourable, if the holder for the nozzle is adjustable in transverse and/or height direction. Due to this adjustability the device can be adapted to the dimensions of the workpieces to be painted or coated together with the recesses therein. Further, the holder is formed as a linear guide aligned to the workpiece longitudinal axis. It is conceivable that several mounting plates are provided at the sides of the frame such that the transferred workpiece can be coated in one cycle.

It is recommendable, that the holder is formed as rotatable collar or rotating assembly and the nozzle is arranged at the periphery of the collar. It is also favourable, if the nozzle is formed adjustable in horizontal, vertical and/or radial direction and has at least three degrees of freedom. The arrangement of an adjustable nozzle at a rotatable collar enables that even complex structures (openings, recesses, chamfers etc.) of workpieces passing through the device are coated or painted in a single operation.

In order to further improve the adjustment of the nozzle in radial direction, it is advantageous that a curve rail is provided to deviating the nozzle movement from a rotation into a largely linear respectively radial movement. Due to this adjustable radial movement of the nozzle it is ensured that the nozzles always keep the equal distance to the workpiece surface in response to the workpiece geometry. Thus, uniform application of the material is ensured on the surface of complicated or inclined recesses etc. Such a control in the respective space axis (and/or around it) is advantageous if only partial ranges of the workpiece, e.g. the faces of the rafters are painted/glazed, which exceed latter from the roof framing over the masonry. For instance it is possible to paint the inclined surface of the rafter intensively at the foot end.

It is favourable, that the rotation of the collar is carried out by a crank stroke transmission engaging at the collar periphery and/or a belt drive. For example, the stroke transmission accomplishes the movement into a circumferential direction of the collar, whereas the return movement is carried out by a belt drive. Of course, it is possible to accomplish the rotation of the collar (e.g. over +/−90°) only via a crank slot or a belt drive. In addition, a rotation of the collar is carried out up to 360°. By rotation of the collar around 360° the arrangement of a single nozzle at the collar periphery is sufficient in order to reach all surface portions of the workpiece. However, if two or more nozzles are arranged at the collar periphery, it is sufficient to have a rotatability of the collar around 180° or only 90°, in order to accomplish a full surface application for coating on the workpiece surface. With that arrangement of more than two nozzles an acceleration of the painting process is achieved. Thus, a further reduction of the cycle times can be realized.

Pretty often the joined workpieces have inclined faces, whose coating/finishing is difficult. In order to provide a satisfactory coating of these faces, it is favourable that the holder is formed pivotable towards the workpiece longitudinal axis. By pivoting the holder towards the faces or other inclined surfaces of the workpiece an optimum coating of the workpiece can be performed. Thus, manual rework of the front faces or other inclined surfaces of the workpiece can be avoided and productivity can be further increased.

In order to apply various coating materials, f. i. multi colour paints or coating agents with different chemical properties by the same device, it is possible to arrange several nozzles next to each other at the holder. A multiplicity of holders that are hung up in series at the device is preferred. Thus, a shut down of the entire system can be avoided on failure of one nozzle.

The inventive process for coating a workpiece, and here in particular for painting a wooden workpiece from a scantling or joinery system covers the subsequent steps:

First, at least one record stored in a memory is selected. The record include information on workpiece geometry. As next step transfer of the record into control commands for the movement of the above described device for coating of the workpiece is carried out. It is favourable that the information from the record are additionally transferred into control commands for the nozzle adjustment and/or movement, e.g. the pivoting of the holder.

Exact data on the workpiece geometry are of particular importance mainly with the operation of an automatic scantling or joinery system. Thus, it is advantageous that the record is passed on the memory device with information on the workpiece geometry (e.g. length, depth, slope of a reaming) from the control of the upstream scantling or joinery system. The invention process thus enables a fully automated and continuous working progress of the delivery of the unprocessed workpiece blanks over the scantling system up to the coating and shipping the coating operation.

Further, it is favourable that the record is read out from a central memory device with information on workpiece geometry after identification of the individual workpiece. Here it is recommendable that the workpiece has identification means, f. i. a machine-readable code. For example this code can be mounted on the workpiece in form of a bar code after processing in the scantling system or in each other upstream processing station to be then detected by corresponding readers at the device for coating the workpiece.

On automatic processing of the workpiece and an automated coating it is important to consider the alignment of the workpiece with the control of the movements of the holder. Thus, it is favourably on start of the coating operation to detect the exact alignment of the workpiece as well as a corresponding adaptation of the movement to approach at this alignment. The system for coating of a workpiece, in particular from a upstream scantling or joinery system includes a loading system for the workpiece to the above described device for coating the workpiece, a removal device for the coated workpiece, a controller for the movement of the loader, of the device for coating of the workpiece and/or of the removal device, a memory device for records with information on the workpiece geometry as well as a device for transferring the records to the controller. The system includes data for movement of the loader, of the device for coating the workpiece and/or of the removal device relative to the workpiece geometry. With the system the subsequent exemplary represented operation is performed.

A wooden workpiece processed on a scantling or joinery system is handed over by the loader to the device for coating the workpiece. As loading systems all types are suitable, f. i. linear conveyer systems or transport vehicles without driver. By the use of corresponding loading systems it is possible, to set up the components of the system at different locations. The workpiece transported to the device for coating the workpiece is now passed through the device and thus coated with the coating material. When passing the workpiece through the coating device a control of the device movement is carried out, i.e. the movement of the holder as well as the nozzles according to the workpiece geometry. The records with information on the workpiece geometry are selected before starting the coating operation from memory means and passed on to the controller. Compiling the records can be made by computer aided manufacture software (CAD/CAM programmes). After the coating process the coated workpiece is further transported by the removal device. For this removal the mentioned linear motion devices are suitable; however, the use of transport vehicles or transport systems is also possible, which can include drying means, for example fans or lamps to ensure the hardening or drying of the coating material during the transport. The removal device can transport the workpieces to a subsequent packaging or shipping station. In order to reach an optimum coating of all surfaces of the workpiece, it is favourable, that the system has an additional device for rotation or alignment of the workpiece. This system can be arranged upstream of the coating device. Such a rotation or adjustment device can effect an optimum feeding of the workpiece to the coating device.

If the rotation or adjustment device is arranged downstream, it can be used for optimum alignment of the workpiece for drying of the coated workpiece. Of course, it is also possible to arrange a rotation or adjustment device on both sides of the device for coating the workpiece. The records with information on the workpiece geometry are selected from the upstream scantling or joinery system and are passed to the memory of the system. The memory communicates with the device for the transfer of the records to the controller, that accomplishes the movements of the loader as well as of the coating device in accordance with the workpiece geometry.

It is favourable to implement the memory as central data memory of the system. In order to verify the information on the workpiece geometry recovered from the records, the system preferably has an additional detector for the geometry of the workpiece or its alignment.

Other advantages, features and characteristics of the invention result from the subsequent description of preferred, but not restrictive embodiments of the invention on the basis the schematic figures. They show in:

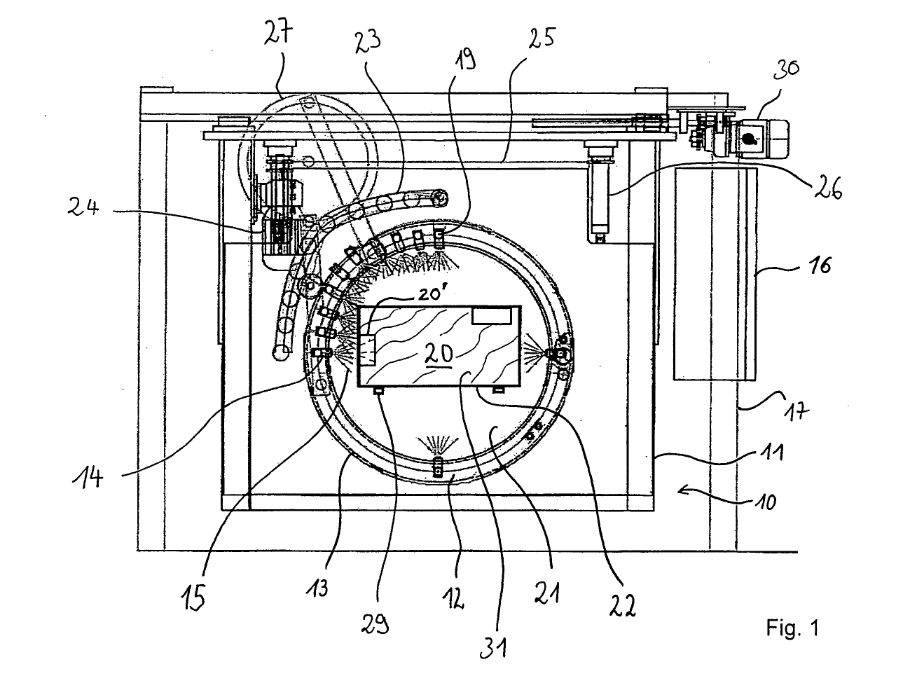

FIG. 1 a preferred embodiment of the device for coating a workpiece;

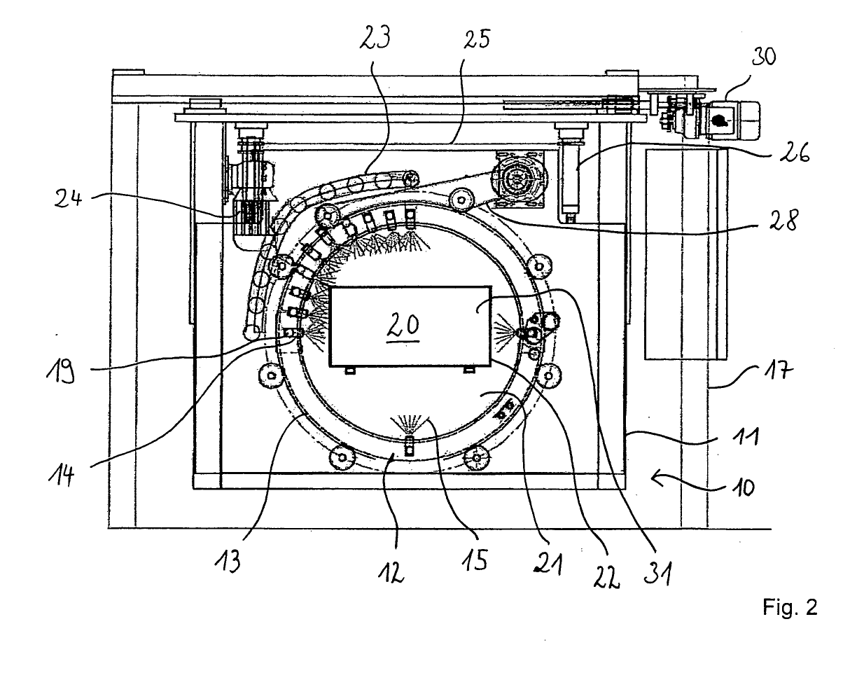

FIG. 2 another preferred embodiment of the device;

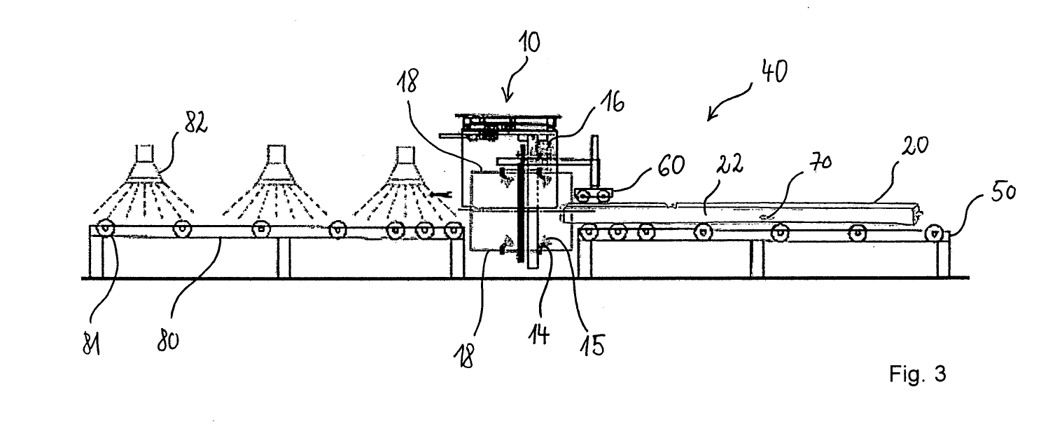

FIG. 3 a system, that comprises the device in side view; and

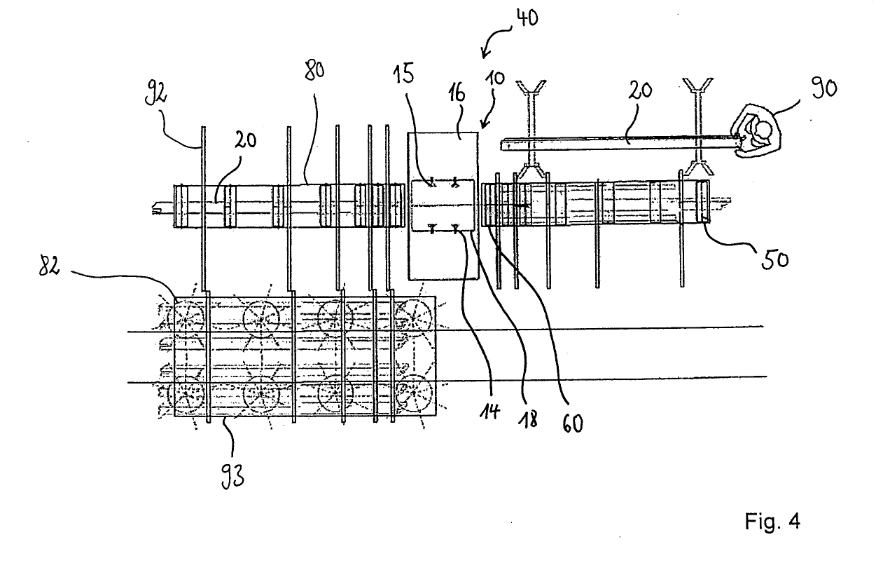

FIG. 4 a preferred embodiment of the system in plan view.

FIG. 1 shows a device 10 for coating a workpiece 20, wherein a holder 11 for at least one nozzle 14 is arranged in a fixed frame 17 to be aligned to the workpiece 20 to be coated. The holder 11 has a rotating assembly 12, at which periphery 13 multiple nozzles 14 are arranged, from which the coating material 15 discharges. In the embodiment of FIG. 1 the rotating assembly 12 is rotatable around 90°. While the rotation of the rotating assembly 12 the coating material 15 discharges from the nozzles 14 and adheres to the surfaces 22 of the workpiece 20, while it is passed through the device 10. In the embodiment of the FIG. 1 the rotating assembly 12 is formed as circular element. However, another form is conceivable, for example two opposite U- or L-rails, at which the nozzles 14 are arranged. Further, it is possible to construct the rotating assembly 12 in a segmented manner. Thus, the device 10 with a segmented rotating assembly 12 allows adaptation of the size of the inlet opening 21 to most cross sections of the workpiece 20.

The nozzles 14 are arranged at the periphery of the rotating assembly 12 and are adjustable in horizontal, vertical and/or radial direction. Due to these adjustability of the nozzles 14 all surfaces 22 of the workpiece 20 can be coated on rotation of the rotating assembly 12, even if this there are rough structures, cuts or steps without using several coating operations. Horizontal and vertical movement of the nozzles 14 is performed via joints 19, whereas the displacement in radial direction is carried out via a curve rail 23. This curve rail 23 transmits the rotational movement of the nozzles 14 to a largely linear or radial movement in accordance with the workpiece geometry and ensures an almost equal distance of the nozzles 14 to the surface 22 of the workpiece 20. Thus, an uniform application of the coating material 15 is performed. The nozzle 14 can also spray into a pocket 20′ at the left side surface of the beam 20. By swivelling of the nozzle 14 (either at the joint 19 and/or by the rotating assembly 12) around a few degrees of angle (e.g. over +/−20°) in the plane of the drawing also the upper and lower sides of the recess or pocket 20′ (a purlin mount) can be sprayed as well.

The frame 11 in the embodiment of the FIG. 1 is adjustable in height and transversely. In order to accomplish this vertical adjustment, the device 10 has an electric motor 24, that is suspended at the frame 11 and operates the adjusting member 26 for the vertical adjustment via a drive belt 25. Likewise, that electric motor 24 drives a crank stroke transmission 27, which engages at the periphery 13 of the rotating assembly 12 to drive the rotating assembly 12 around the longitudinal axis. Further, the device 10 has an additional motor 30 for pivoting and/or transverse movement of the holder 11. By pivoting the holder 11 towards the workpiece longitudinal axis it is possible to coat inclined faces 31 of the workpiece 20 (e.g. foot end of rafters).

In the embodiment of FIG. 1 the rotating assembly 12 rotates around 90°. Due to several nozzles 14 at the periphery 13 of the rotating assembly 12 it is possible to perform a coating of all surfaces 22 of the workpiece 20 in one operation. If only two nozzles 14 are provided at the periphery 13 of the rotating assembly 12, a rotation of the rotating assembly 12 will be around 180°, in order to coat all surfaces 22 of the workpiece 20. If only one nozzle 14 is provided at the periphery 13, a corresponding coating effect requires a rotation of the rotating assembly 12 up to 360°.

In the shown embodiment the workpiece 20 is supported on a conveyor 29 for transport through the fixed coating device 10.

FIG. 2 shows a device 10 for coating a workpiece comparable with the device 10 of FIG. 1. Instead of a crank stroke 27 for the rotation of the rotating assembly 12, the device 10 in FIG. 2 has a belt drive 28 for the rotating assembly 12. Here again, a rotation of the rotating assembly 12 around only 90° is provided, as the plurality of nozzles 14 at the periphery 13 of the rotating assembly 12 achieve a coating of all surfaces 22 of the workpiece 20 already by a rotation around 90°.

In addition to the electric motor 24 that effects the rotation and vertical adjustment of the holder 11, the device 10 illustrated in FIG. 2 has an motor 30 for pivoting of the holder 11. With this pivoting of the holder 11 (out of the vertical direction) towards the workpiece longitudinal axis it is possible to coat inclined faces 31 of the workpiece 20. Each of the arranged nozzles 14 of the rotating assembly 12 has an own supply for the coating material 15. Thus, it is possible with a single holder 11 and a sufficient number of nozzles 14 to apply various coating materials 15 via the same holder 11 and in a single operation. In response of the information from the controller the application of the coating material 15 can also follow successively, so that parts of the workpiece 20 are coated with a first coating material 15, while other portions are applied with a second, third etc. coating material 15.

FIG. 3 schematically shows a system 40, which includes a device 10 for coating a workpiece 20, as described. The system 40 in the embodiment of the FIG. 3 has a loader 50 to supply bar-like workpieces 20 to the downstream device 10 for coating. Upstream of the device 10 the system 40 has an alignment device 60 that guarantees an aligned feeding of the workpiece 20 to the device 10. Upstream of the feeder 50, a scantling or joinery system (not shown in FIG. 3) is arranged for milling and/or cutting recesses 70 in the workpiece 20. From the scantling system the data and/or the records with information on the workpiece geometry (location of the recesses, their depth etc.) are passed to the controller 16 at the device 10 such that on the basis of the provided information a control of the motion of the device 10 and/or the alignment of the nozzles 14 can take place (here arranged at covers 18).

Due to this control is it possible to reach all recesses 70 in the workpiece 20 uniformly in a single operation with the coating material 15. After passing the device 10 the workpiece 20 is taken by the removal device 80 for transport of the workpiece 20, e.g. by a role conveyor 81 with lamps 82 for drying of the coated surfaces 22. After the drying process on the removal device 80 the workpiece 20 can be passed to downstream working, packaging or transportation stations (not shown).

In FIG. 4 the system 40 of FIG. 3 is shown in plan view. In difference to FIG. 3, the loader 50 of the system 40 is fed in a manual method, i.e. the joined workpieces 20 are transported to the system 40 and subsequent placed on the loader 50 by an operator 90. The system 40 in the embodiment of FIG. 4 has detecting means (not shown) for a code mounted at the workpieces 20, such that the workpiece 20 is uniquely identified. After identification of the workpiece 20 the associated record with geometrical information is used for the control of the device 10 for the coating, i.e. selected from a central memory and processed for the control of the device 10 in the controller unit 16. After supply of the workpiece 20 to the device 10 the coating process begins together with proper alignment of the workpiece 20 as checked by corresponding detecting means (not shown). If the workpiece 20 is not properly aligned, the system 40 shown in FIG. 4 has an additional alignment device 60 for the workpiece 20, to align it to the corresponding set points. The loader 50 leads the workpiece 20 through the device 10 up to the removal device 80 downstream of the device 10. In the embodiment a multiplicity of linear movers 92 are aligned vertical to the feed direction of the workpiece 20 and pass the workpiece 20 to a transport cart 93, which is here furnished with lamps 82. After a complete filling of the transport cart 93 it moves automatically to the packaging station (in FIG. 4 not shown) and an empty transport cart 93 is advanced to the system 40.

### REFERENCE SYMBOL LIST

10=device
11=holder
12=rotating assembly
13=periphery
14=nozzle
15=coating material
16=controller
17=frame
18=cover
19=joint
20=workpiece
21=opening
22=surface
23=curve rail
24=electric motor
25=drive belt
26=adjusting member
27=crank stroke transmission
28=belt drive
29=conveyor
30=motor
40=system
50=loader
60=alignment device
70=recesses
80=removal device
81=role conveyor
82=lamp
90=operator
92=linear movers
93=transport cart

1. Device (10) for coating an elongated workpiece (20), particularly for painting or impregnating a joined wooden workpiece, having at least one nozzle (14), directed toward the workpiece (20),
characterised in that
the nozzle (14) is disposed on a holder (11) aligned substantially perpendicular to the workpiece longitudinal axis and being suspended in a frame (17).

2. Device (10) according to claim 1, characterised in that the holder (11) is adjustable in vertical and/or transverse direction.

3. Device (10) according to one of the preceding claims, characterised in that the holder (11) is formed as linear guide perpendicular to the workpiece longitudinal axis.

4. Device (10) according to claim 1 or 2, characterised in that the holder (11) is formed as rotating assembly (12) and the nozzle (14) is arranged at the rotating assembly (12).

5. Device (10) according to one of the preceding claims, characterised in that the nozzle (14) is adjustable in horizontal, vertical and/or radial direction.

6. Device (10) according to claim 5, characterised in that a curve rail (23) is provided for the movement of the nozzle (14) in radial direction

7. Device (10) according to one of the claims 4 to 6, characterised in that the rotation of the rotating assembly (12) is carried out via a crank stroke transmission (27) and/or a belt drive (28), that engages the periphery (13), wherein a rotation of the rotating assembly (12) up to 360°, in particular up to 180°, preferably up to 90° is provided.

8. Device (10) according to one of the preceding claims, characterised in that the holder (11) is pivotable towards the workpiece longitudinal axis.

9. Device (10) according to one of the preceding claims, characterised in that a multiplicity of holders (11) are arranged in series.

10. Method for coating an elongated workpiece (20), particularly for painting or impregnating a wooden workpiece from a scantling or joinery system, comprising the steps:
reading at least one record with information on the workpiece geometry, stored in memory means, and
transferring of the record into control commands for movement of the workpiece and/or the device (10) for coating the workpiece (20) according to one of claims 1 to 9.

11. Method according to claim 10, characterised in that the record is additionally compiled into control commands for nozzle adjustment and/or for pivoting of the holder (11).

12. Method according to one of the claim 10 or 11, characterised in that records from the control of a scantling or joinery system are passed to memory means and/or are selected from a central memory after identification of the workpiece (20).

13. System (40) for coating an elongated workpiece (20), particularly for painting or impregnating from a wooden workpiece transferred from a scantling or joinery system, comprising:
a loader (50) for the workpiece (20) to the system (40),
at least one device (10) for coating the workpiece (20) according to one of claims 1 to 9,
a removal device (80) for the coated workpiece (20) from the system (40),
a controller for movement of the loader (50), the device (10) for coating the workpiece (20) and/or the removal device (80),
a memory for records with information on the workpiece geometry, and
an unit for the transfer of the records to the controller,
wherein movement of the feeder (50), of the device (10) for coating the workpiece (20) and/or of the removal device (80) is based on the information on the workpiece geometry.

14. System (40) according to claim 13, characterised in that an additional alignment device (91) is provided for the rotation and/or alignment of the workpiece (20).

15. System (40) according to one of the claim 13 or 14, characterised in that an additional record with information on the workpiece geometry is transferred from the scantling or joinery system after identification of the transferred workpiece.
